(19) United States
(12) Patent Application Publication
(10) Pub. No.: US 2010/0297437 A1
(43) Pub. Date: Nov. 25, 2010

(54) Coating Structure with a Metal-Like Luster and Zero Energy Attenuation of Radio-Frequency

(76) Inventor: Fu-Hsin TSAI, Sioushuei Township (TW)

Correspondence Address: Dr. BANGER SHIA;Patent Office of Bang Shia, 102 Lindencrest Ct., Sugar Land, TX, 77479-5201, US

(21) Appl. No.: 12/471,374

(22) Filed: May 23, 2009

(51) Int. Cl. B32B 15/00

(52) U.S. Cl. 428/336

(57) ABSTRACT

A coating structure with a metal-like luster and zero energy attenuation of radio-frequency for 3C products comprises a substrate, a reflection increasing adhesive layer, a Ge or Ge alloy layer, a colored adhesive layer and a protecting layer. With the Ge or Ge alloy layer, the coating structure has a metal-like luster and zero energy attenuation of radio-frequency.

### BACKGROUND OF THE INVENTION

1. Field of the Invention

The present invention relates to a coating structure, and more particularly to a coating structure with a metal-like luster and zero energy attenuation of radio-frequency for 3C products.

2. Description of the Prior Art

3C products refer to computer, communication and consumer electronics products.

With the development of the information industry, the internal function of the 3C products is gradually mature. Currently, appearance is one of the important factors affecting consumer. Hence, the surface technology of the 3C products is springing day today. The existing two kinds of materials, the engineering plastic and light metal, are widely applied in 3C products to not only provide internal structure support for the 3C products but improve product aesthetics. The engineering plastic has the advantages of better formability and low cost. The light metal has the advantages of excellent rigidity and strength, and better electromagnetic wave resistance and heat dissipation. Presently, the 3C products are still mostly made of the engineering plastic.

In order to have a metallic luster, the existing 3C products are provided with a metal coating 90 (as shown in FIG. 1) including a substrate 91 and a chromium-atom layer 92 bonded onto the substrate 91 or including a substrate 93 (as shown in FIG. 2) which is made of an aluminum-atom layer, tin-atom layer, indium-tin alloy layer or silicon-aluminum alloy layer. Further analysis shows that the above conventional metal coating for 3C products has the following disadvantages:

1. The metal coating 90 for 3C products has the property of reflection attenuation and absorption of radio-frequency, which adversely affects the signal transmission of the 3C products, thus deteriorating the quality of the 3C products.

2. The metal coating 90 for 3C products doesn't have an attractive appearance since film thickness uniformity in multi-dimensional space is difficult to control.

The present invention has arisen to mitigate and/or obviate the afore-described disadvantages.

### SUMMARY OF THE INVENTION

The primary objective of the present invention is to provide a coating structure with a metal-like luster and zero energy attenuation of radio-frequency for 3C products, which can give a metal-like luster to the 3C products and ensure a smooth signal transmission.

In order to achieve the above objective, a coating structure with a metal-like luster and zero energy attenuation of radio-frequency for 3C products in accordance with the present invention comprises in sequence a substrate, a reflection increasing adhesive layer, a Ge or Ge alloy layer having a thickness ranging from 300 Å to 700 Å, a colored adhesive layer and a protecting layer. Further analysis shows that the coating structure with a metal-like luster and zero energy attenuation of radio-frequency for 3C products in accordance with the present invention has the following functions:

1. The coating structure with a metal-like luster and zero energy attenuation of radio-frequency for 3C products utilizes the Ge or Ge alloy which are non-conductive materials to avoid adversely affecting the wireless transmission of the 3C products, thus improving the quality of the 3C products in terms of signal transmission.

2. The coating structure with a metal-like luster and zero energy attenuation of radio-frequency for 3C products utilizes the protecting layer to withstand wear to keep the 3C products having the metal-like luster.

3. The coating structure with a metal-like luster and zero energy attenuation of radio-frequency for 3C products utilizes the reflection increasing adhesive layer and the colored adhesive layer to increase the bonding capacity between layers while utilizing the reflection increasing adhesive layer to improve reflection and enhance luster and utilizing the colored adhesive layer to change color.

### BRIEF DESCRIPTION OF THE DRAWINGS

FIG. 1 is a cross sectional view of a conventional coating structure for 3C products;

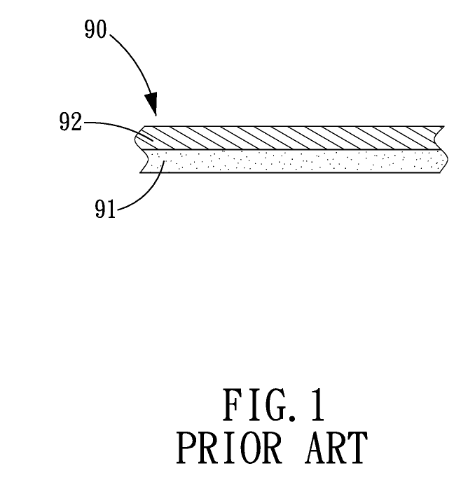

FIG. 2 is a cross sectional view of another conventional coating structure for 3C products; and

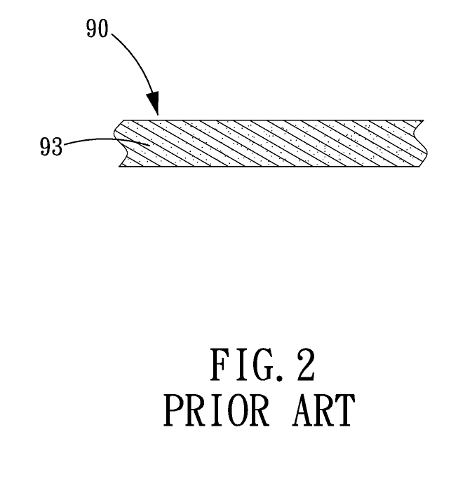

FIG. 3 is a cross sectional view of a coating structure with metal-like luster and zero energy attenuation of radio-frequency for 3C products in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

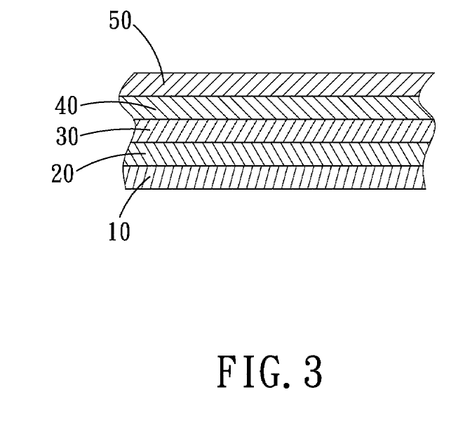

Referring to FIG. 3, a coating structure with a metal-like luster and zero energy attenuation of radio-frequency for 3C products comprises a substrate 10, a reflection increasing adhesive layer 20, a Ge or Ge alloy layer 30, a colored adhesive layer 40 and a protecting layer 50.

The substrate 10 is integrally formed of a material selected from a group consisting of acrylonitrile-butadiene-styrene (ABS), polycarbonate/acrylonitrile-butadiene-styrene (PC/ABS), polycarbonate (PC), polymethylmethacrylate (PMMA), and polycarbonate/polymethylmethacrylate (PC/PMMA).

The reflection increasing adhesive layer 20 is integrally formed of an UV (ultraviolet) curable adhesive and bonded onto the substrate 10. The reflection increasing adhesive layer 20 is disposed on a surface of the substrate 10 to enhance light reflectance.

The Ge or Ge alloy layer 30 has a thickness ranging from 300 Å to 700 Å and a resistance greater than 1000 MΩ. The Ge or Ge alloy layer 30 is bonded onto the reflection increasing adhesive layer 20 by vacuum plating of physical vapor deposition (PVD). The vacuum plating is selected from a group consisting of vacuum sputtering, vacuum ion plating and vacuum resistance heating evaporation. The reflection increasing adhesive layer 20 bonds the Ge or Ge alloy layer 30 to the substrate 10. The non-metal character of the Ge or Ge alloy layer 30 of the coating structure of the present invention won't block the wireless transmission while providing a metal-like luster to the 3C products.

The colored adhesive layer 40 is integrally formed of polyurethane resin and a coloring material and changes in color by changing the coloring material. The colored adhesive layer 40 is bonded onto the Ge or Ge alloy layer 30.

The protecting layer 50 is integrally formed of an UV curable adhesive and bonded onto the colored adhesive layer 40. The protecting layer 50 having an anti-wear property is used to protect the metal-like luster of the coating structure. The colored adhesive layer 40 bonds the protecting layer 50 to the Ge or Ge alloy layer 30.

While we have shown and described various embodiments in accordance with the present invention, it is clear to those skilled in the art that further embodiments may be made without departing from the scope of the present invention.

What is claimed is:

1. A coating structure with a metal-like luster and zero energy attenuation of radio-frequency for 3C products, comprising:
a substrate;
a reflection increasing adhesive layer being bonded onto the substrate;
a Ge or Ge alloy layer having a thickness ranging from 300 Å to 700 Å and being bonded onto the reflection increasing adhesive layer, the reflection increasing adhesive layer bonding the Ge or Ge alloy layer to the substrate;
a colored adhesive layer being bonded onto the Ge or Ge alloy layer; and
a protecting layer being bonded onto the colored adhesive layer and bonded to the Ge or Ge alloy layer by the colored adhesive layer.

2. The coating structure with a metal-like luster and zero energy attenuation of radio-frequency for 3C products as claimed in claim 1, wherein the substrate is integrally formed of a material selected from a group consisting of a group consisting of acrylonitrile-butadiene-styrene, polycarbonate/ acrylonitrile-butadiene-styrene, polycarbonate, polymethylmethacrylate, and polycarbonate/polymethylmethacrylate.

3. The coating structure with a metal-like luster and zero energy attenuation of radio-frequency for 3C products as claimed in claim 1, wherein the reflection increasing adhesive layer is integrally formed of an UV curable adhesive.

4. The coating structure with a metal-like luster and zero energy attenuation of radio-frequency for 3C products as claimed in claim 1, wherein the Ge or Ge alloy layer has a resistance greater than 1000 MΩ.

5. The coating structure with a metal-like luster and zero energy attenuation of radio-frequency for 3C products as claimed in claim 1, wherein the Ge or Ge alloy layer is bonded onto the reflection increasing adhesive layer by vacuum plating of physical vapor deposition.

6. The coating structure with a metal-like luster and zero energy attenuation of radio-frequency for 3C products as claimed in claim 5, wherein the vacuum plating is selected from a group consisting of vacuum sputtering, vacuum ion plating and vacuum resistance heating evaporation.

7. The coating structure with a metal-like luster and zero energy attenuation of radio-frequency for 3C products as claimed in claim 5, wherein the colored adhesive layer is integrally formed of polyurethane resin and a coloring material.

8. The coating structure with a metal-like luster and zero energy attenuation of radio-frequency for 3C products as claimed in claim 1, wherein the protecting layer is integrally formed of an UV curable adhesive.
